(19) United States
(12) Patent Application Publication
(10) Pub. No.: US 2011/0048128 A1
(43) Pub. Date: Mar. 3, 2011

(54) Double Conical Measuring Beaker

(75) Inventor: William A. Groll, McMurray, PA (US)

(73) Assignee: ALL-CLAD METALCRAFTERS LLC, Canonsburg, PA (US)

(21) Appl. No.: 12/874,268

(22) Filed: Sep. 2, 2010

Related U.S. Application Data
(60) Provisional application No. 61/239,444, filed on Sep. 3, 2009.

(51) Int. Cl. G01F 19/00

(52) U.S. Cl. 73/427

(57) ABSTRACT

A combined conical measuring beaker combining two truncated conically shaped portions of differing volumes joined together, wherein each of the portions has volumetric measuring markings applied along respective sidewalls of each portion.

### CROSS-REFERENCE TO RELATED APPLICATION

This application claims priority to U.S. Provisional Application No. 61/239,444 filed Sep. 3, 2009, which is incorporated hereby by reference in its entirety.

### BACKGROUND OF THE INVENTION

1. Field of the Invention

The present invention relates to a kitchen volumetric measuring beaker with newly-developed features which add to its visibility and usefulness.

2. Description of Related Art

Conical measuring beakers with volume markings are known in the art. These conical beakers are individual cones and tend to be about 1 L to 2 L in volume. Conical beakers are more accurately read than cylindrical beakers, particularly at lower volume measurements. These prior conical beakers are graduated down to measurements as small as 50 milliliter (ml) to 100 ml (or several ounces) but are still difficult to read near the bottom of the conical vessel. The present invention addresses this problem.

### SUMMARY OF THE INVENTION

The double conical measuring beaker of my invention is made by attaching the smaller truncated ends of two conically shaped vessels of different volumes. One vessel has a larger volume than the other, and the ratio of the volumes between the two is on the order of 2:1 to 4:1. The small truncated ends of the conical vessels are permanently attached, forming a sort of uneven or asymmetrical hourglass shape. Both the larger and smaller conical vessels are marked internally with volume markings.

The larger of the two conical vessels is graduated for larger volume measurements and can be easily read. Smaller volume readings can be easily measured in the smaller cup which would be made with a lower conical angle than the larger cup, making the volume markings easier to see. The large conical cup portion serves as a stable base for the beaker when the small cup is in use, and the small cup serves as a stable base for the beaker when the large cup is in use. This double measuring beaker assembly may be made of various types of metal, such as stainless steel or aluminum, glass, ceramic, or plastic materials. Volume markings may be applied to an interior sidewall by popular techniques such as laser, acid etch, embossing or molding.

### BRIEF DESCRIPTION OF THE DRAWINGS

FIG. 1 is a perspective view of the combined conical measuring beaker of the invention;

FIG. 2 is a side elevation view of the combined conical measuring beaker of the invention; and

FIGS. 3-5 are side elevation views of the conical measuring beaker of the invention with FIGS. 3 and 4 being in cross section.

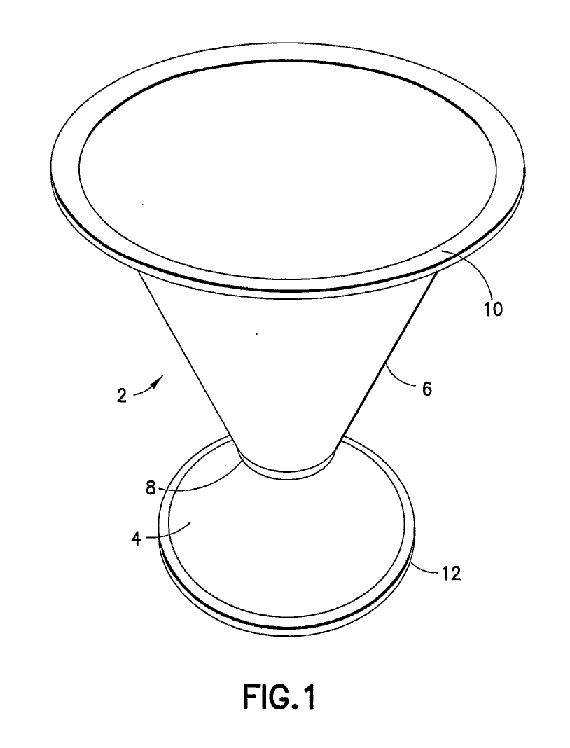

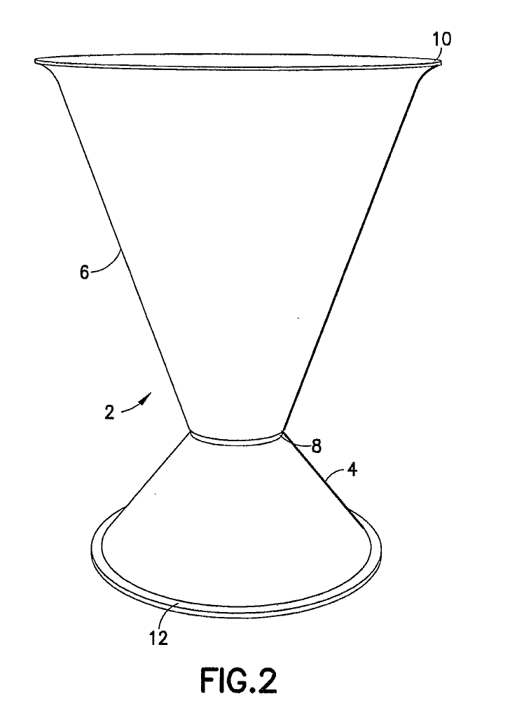

### DETAILED DESCRIPTION OF THE INVENTION

Referring to the drawings, the combined conical measuring beaker 2 of the present invention is shown. The combined measuring beaker 2 comprises two truncated conically shaped vessel portions, namely, a smaller conically shaped portion 4 and a larger conically shaped portion 6. The conically shaped portions or cups 4 and 6 are joined together along a common diameter 8 of the smallest diameter of either portion. The volumetric ratios of each of the portions 4 and 6 can vary wherein the ratio of the volume between the larger conically shaped portion 6 and the smaller conically shaped portion 4 is preferably between about 2:1 to 4:1.

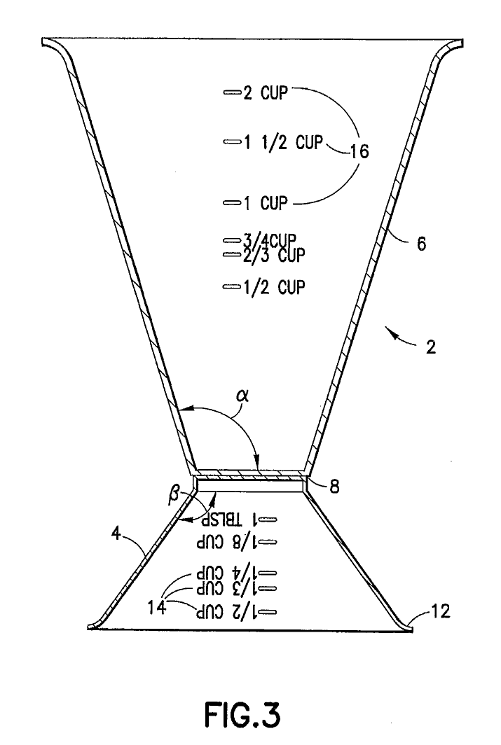

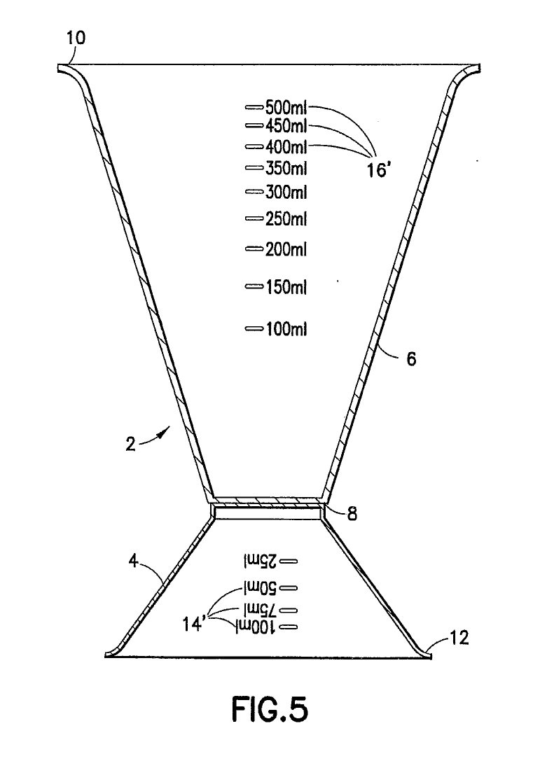

Each of the conically shaped portions 4 and 6 of the measuring beaker 2 have sidewalls which flare outwardly from the common diameter 8 to open rims 10 and 12. The sidewalls of each of the portions 4 and 6 carry volume markings 14 and 16, preferably on the inside of the respective sidewalls to indicate the volumetric amount of a particulate food product to be measured. FIG. 3 shows volume markings 14 and 16 in cups and tablespoons while FIG. 5 shows volume markings 14′ and 16′ in ml values. FIG. 3, for example, depicts the larger conically shaped portion 6 as measuring between ½ and 2 cups while the smaller conically shaped portion 4 measures between 1 tablespoon and ½ cup. FIG. 5, by way of further example, shows the larger conically shaped portion 6 as sized for measuring between 100 ml and 500 ml, while the smaller portion 4 measures between 25 ml and 100 ml. Hence, there is a continuum of volumetric measurements between portions 4 and 6. In other words, the largest volumetric measurement shown for the smaller conical portion 4 (½ cup in FIG. 3; 100 ml in FIG. 5) is the same as the smallest volumetric measurement for the larger conical portion 6 (½ cup in FIG. 3; 100 ml in FIG. 5).

The flared rims 10 and 12 of the conically shaped portions or measuring cups 4 and 6 have respective diameters, particularly the diameter of the smaller portion 4 which is large enough to support the beaker 2 when it is placed on a horizontal surface, such as a kitchen countertop. For example, the rim diameter at rim 12 of the smaller conically shaped portion 4 is of a sufficient dimension, for example about 4 inches, so that it will support the beaker 2 in a stable manner when the larger conically shaped portion 6 is in an upright position and a particulate food product is being poured therein. Conversely, the larger conical portion 6, when inverted, will support the smaller conically shaped portion 4 when inverted in a stable manner. The diameter at rim 10 may be on the order of about 5 inches.

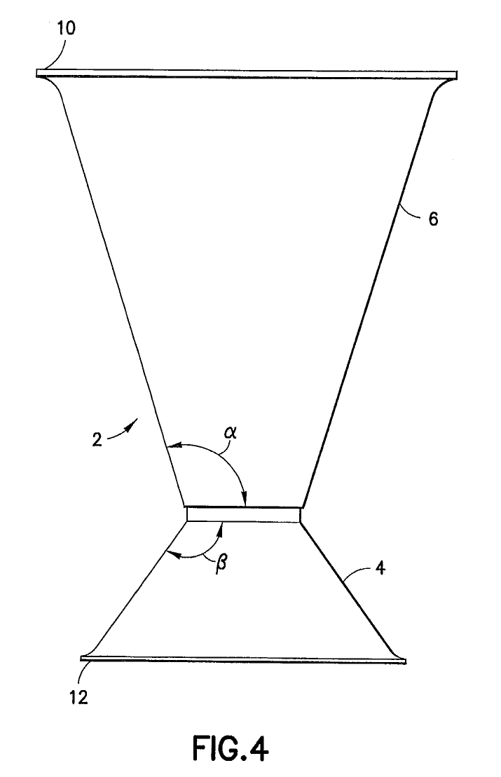

In this way, the volumetric markings 14 and 16 on both of the conical portions or measuring cups can easily be read by virtue of their differing conical angles. The larger cup 6 has a higher conical angle α, making the volume markings 16 easier to read, while the conical angle β of the smaller cup 4 has a lower conical angle, making the volume markings 14 also easier to read, and more accurately, when lower volumetric amounts are being measured. By way of example and in no way limiting, the conical angle α of the larger cup 6 is about 70° while the conical angle β of the smaller cup 4 is about 50°. Conical angle α may range between about 65°-75° and angle β may range between about 45°-55°, FIGS. 3 and 4.

The relative volumetric ratios between the larger and smaller conically shaped portions of between about 2:1 to 4:1 will dictate the final dimensions of the beaker 2.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A combined conical measuring beaker combining two truncated conically shaped portions of differing volumes joined together, wherein each of the portions has volumetric measuring markings applied along respective sidewalls of each portion.

2. The combined measuring beaker of claim 1 wherein a first of the conically shaped portions is of a larger volume than a second of the two conically shaped portions and a volumetric ratio between a larger and a smaller of said conically shaped portions is between about 2:1 to 4:1.

3. The combined measuring beaker of claim 1 wherein the volumetric measuring markings are applied along respective inside sidewalls of each portion.
